(19) United States
(12) Patent Application Publication
(10) Pub. No.: US 2009/0136286 A1
(43) Pub. Date: May 28, 2009

(54) Entry Boot

(75) Inventors: Donald P. Kenney, Mcfarland, WI (US); Jesse Spankowski, Portage, WI (US); Kevin Otte, Madison, WI (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: FRANKLIN FUELING SYSTEMS, INC., Madison, WI (US)

(21) Appl. No.: 12/324,461

(22) Filed: Nov. 26, 2008

Related U.S. Application Data
(60) Provisional application No. 60/990,864, filed on Nov. 28, 2007.

(51) Int. Cl. F16J 15/32

(52) U.S. Cl. 403/51

(57) ABSTRACT

An entry boot that provides a fluid-tight seal between a pipe and a sump wall, wherein some of the components of the entry boot are detachable.

### FIELD OF THE INVENTION

This invention relates to fittings that form an entry boot for providing a fluid-tight seal between a wall and a pipe that passes through an opening in the wall. The invention is particularly applicable, but in no way limited, to the provision of a seal between a pipe and the double-wall of an underground containment sump.

### BACKGROUND OF THE INVENTION

Underground storage tanks or containment sumps with associated piping for holding and transferring fuel or chemicals are well known. Leaks from these underground sumps may occur at an opening in the sump wall where a pipe passes through. It is desirable to provide a fluid-tight seal between these openings in the sump wall and its respective pipe to avoid both the ingress of water into the sump as well as the potential environmental hazard if fuel or chemicals contained within the sump were to leak into the earth.

It is known to employ an entry boot, comprised of a series of fittings, that are permanently attached to both the pipe and the sump wall around the opening to create a fluid-tight seal. With respect to the attachment to the sump wall, some types of fittings are bolted to the sump wall, others comprise two parts that are sandwiched to the inner and outer sides of the sump wall and held together by a screw-threaded connector extending through the opening, and others are permanently joined to the sump wall. With respect to the attachment to the pipe, however, the fittings are typically bonded or welded to the pipe, both of which entail a permanent joint such that the fittings may not be detached.

One type of such fittings is known from US 2007/0057504 (Boudry et al.), which employs windings of electrical heating wire to create an electrofusion joint between the fittings and a pipe passing through an opening of a sump wall. These fittings comprise a first component formed from an electrofusible plastics material compatible with the pipe, and a second component, joined in a substantially fluid-tight manner to the first component, wherein the second component is adapted to be bonded to the sump wall made of glass reinforced plastic. The first component incorporates electrofusion windings and associated terminals designed and adapted to form electrofusion welds to a pipe, either primary or secondary or both.

By creating this electrofusion joint, the component is permanently adhered to the pipe and can not be removed for repair or replacement. In addition, the inability to remove the fittings from the pipe precludes reuse of the entry boot on other piping systems or interchanging the piping with an associated opening in the sump.

### SUMMARY OF THE INVENTION

It is an object of the invention to provide an entry boot for providing a fluid-tight seal between a pipe and a sump wall, wherein some of the components of the entry boot are detachable.

In accordance with an aspect of the invention, the entry boot may comprise a main boot attached to an outer wall of a sump and fitted to a secondary wall pipe, a retainer having grooves compatible with the main boot to permit at least one seal to be wedged between them and adjacent to the secondary wall pipe, a ring attached to an inner wall of the sump and to the main boot, and a flexible boot that attaches to both a primary wall pipe and the main boot via a clamp.

It is contemplated that the main boot and ring may employ a fiberglass joint to permanently attach to the outer and inner walls of the sump, respectively.

It is further contemplated that the main boot may seal an interstitial gap between the inner and outer walls of the sump double-wall.

It is further contemplated that the retainer may be attached to the main boot by some detachable fastener.

It is further contemplated that the flexible boot may be a curved fitting such that it can be attached to both an upper portion of the main boot protruding above the inner wall of the sump and the primary wall pipe, which is radially smaller than the upper portion of the main boot.

It is still further contemplated that the retainer, seal, primary boot and clamp may be detachable such that they can be removed for repair or replacement when necessary.

Other features and advantages of the invention will be apparent from the following specification taken in conjunction with the following drawings.

### BRIEF DESCRIPTION OF THE DRAWINGS

FIG. 1 illustrates a cross-sectional view of a first embodiment of an entry boot for providing a fluid-tight seal between a pipe and sump wall, in accordance with the present invention.

FIG. 2 illustrates a cross-sectional view of a second embodiment of the invention.

### DETAILED DESCRIPTION OF A PREFERRED EMBODIMENT

While this invention is susceptible to embodiments in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated.

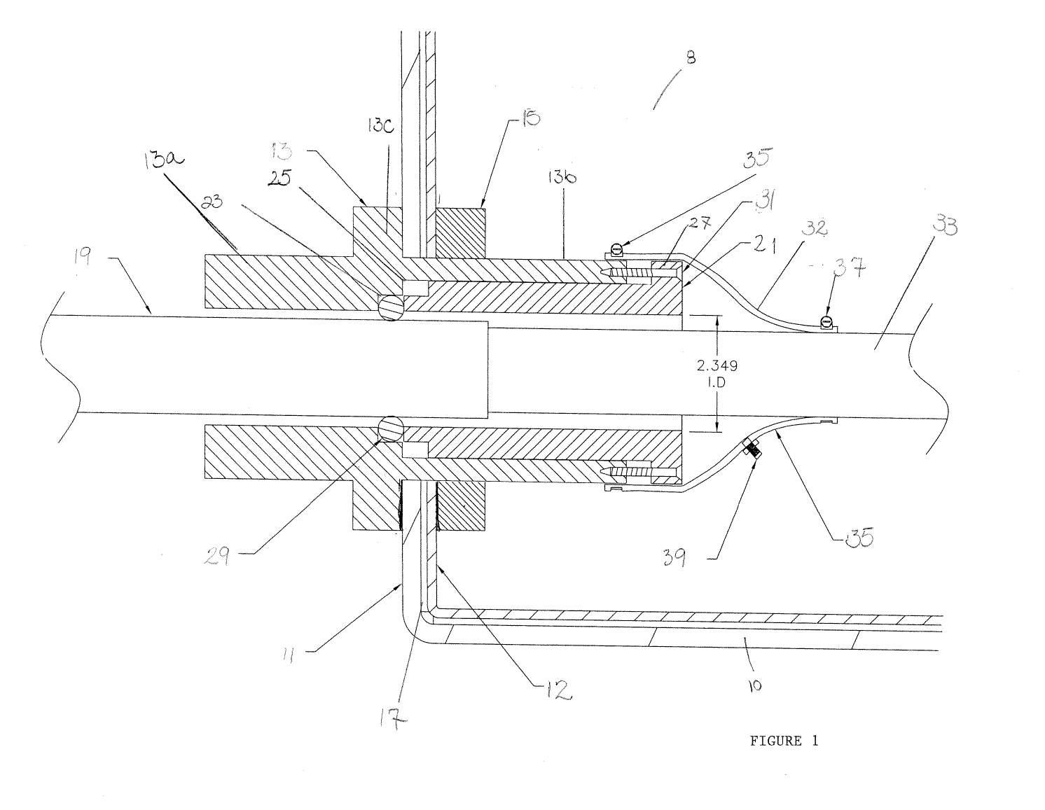

A first embodiment of an entry boot, generally designated 8, in accordance with the invention is illustrated in FIG. 1. A double-wall of a sump 10 is depicted by dashed lines, with an outer wall 11 and an inner wall 12. A fiberglass fitting forming a main boot 13 and a fiberglass retainer forming a ring 15 are permanently adhered to the outer and inner walls 11, 12 of the double-wall, respectively. The main boot 13 includes an outer tubular sleeve 13a on the outside of the chamber, an inner tubular sleeve 13b extending through an opening in the sump 10, and a radially extending flange 13c located between the sleeves 13a and 13b that engages the outer wall 11. The ring 15 is permanently adhered to both the inner wall 12 and a portion of the inner tubular sleeve 13b extending inside the double-wall of the sump 10. A fiberglass joint may be used to permanently adhere the flange 13c and the ring 15 to their respective sides of the double-wall, as well as the ring 15 to inner tubular sleeve 13b. The inner tubular sleeve 13b of main boot 13 extends across and seals an interstitial gap 17 of the double-wall due, in part, to the aforementioned fiberglass joints. The outer tubular sleeve 13a of main boot 13 is also substantially fitted to a flexible secondary wall pipe 19, but is not perfectly fitted, allowing for some degree of curvature that the flexible secondary pipe 19 may have. Since the ring 15 is also permanently attached to the main boot 13, the ring 15 provides further axial support for the entry boot 8. The main boot 13 and the ring 15 are the only non-detachable components of the entry boot 8 design.

The main boot 13 contains a mating groove such that the main boot 13 can mate with a retainer 21. The entry boot 8 in FIG. 1 includes three mating grooves: a first mating inner-groove 23, a second mating inner-groove 25, and a mating outer-groove 27. The first mating inner-groove 23 is in the outer tubular sleeve 13a of main boot 13 and is closest to the secondary wall pipe 19. The second mating inner-groove 25 is also in main boot 13 and is proximate to the first mating inner-groove 23. The mating outer-groove 27 is in the retainer 21 and is radially further than both mating inner-grooves 23 and 25. The inner diameters of main boot 13 and the retainer 21 are similarly sized such that they both have a substantial fit over the secondary wall pipe 19. A seal 29, such as an O-ring, is wedged inside the first mating inner-groove 23, between the outer tubular sleeve 13a of main boot 13 and the retainer 21, such that the seal 29 is adjacent to the secondary wall pipe 19.

The retainer 21 is attached to the main boot 13 via a fastener 31, such as a bolt or screw. This fastener 33 secures the surfaces of the retainer 21 and inner tubular sleeve 13b of main boot 13 that form the mating outer-groove 27. Since the fastener 31 is inserted axially and located at a radial distance further than the mating inner-grooves 23 and 25, the fastener 31 does not interfere with the seal 29. When the main boot 13 and the retainer 21 properly mate with each other at both the second mating inner-groove 25 and the outer mating-groove 27, the seal 29 will be sufficiently compressed by the retainer 21 to provide an adequate seal for the entry boot 8. Also, including the second mating inner-groove 25 provides added structural support for the retainer 21, which would otherwise only be as wide as the thickness of the seal 29.

Finally, a flexible boot 32 is provided comprising a curved fitting that is appropriately sized to fit on the outside surface of inner tubular sleeve 13b of main boot 13, and at the top to fit around a wall of a primary pipe 33, which extends substantially inside the sump 10 and is contained within secondary wall pipe 19. The primary pipe 33 has a smaller diameter than the secondary wall pipe 19, which extends substantially outside the sump 10. The flexible boot 32 is sealed to the inner tubular sleeve 13b of main boot 13 and to the primary wall pipe 33 via first and second clamps 35, 37, respectively, such as by a band clamp. An air valve 39 is located on a curved portion of flexible boot 32. The air valve 39 may be used to adjust and measure air pressure fluctuation in the space contained between the flexible boot 32, the retainer 21, the seal 29, and the primary and secondary 33 and 19. Any pressure fluctuation detected may indicate a leak in the sump and that certain components of the entry boot may need to be repaired or replaced.

The retainer 21, seal 29, flexible boot 32, first and second clamps 35, 37, and fastener 31, are all removable components of the entry boot design that can be removed for repair or replacement as necessary.

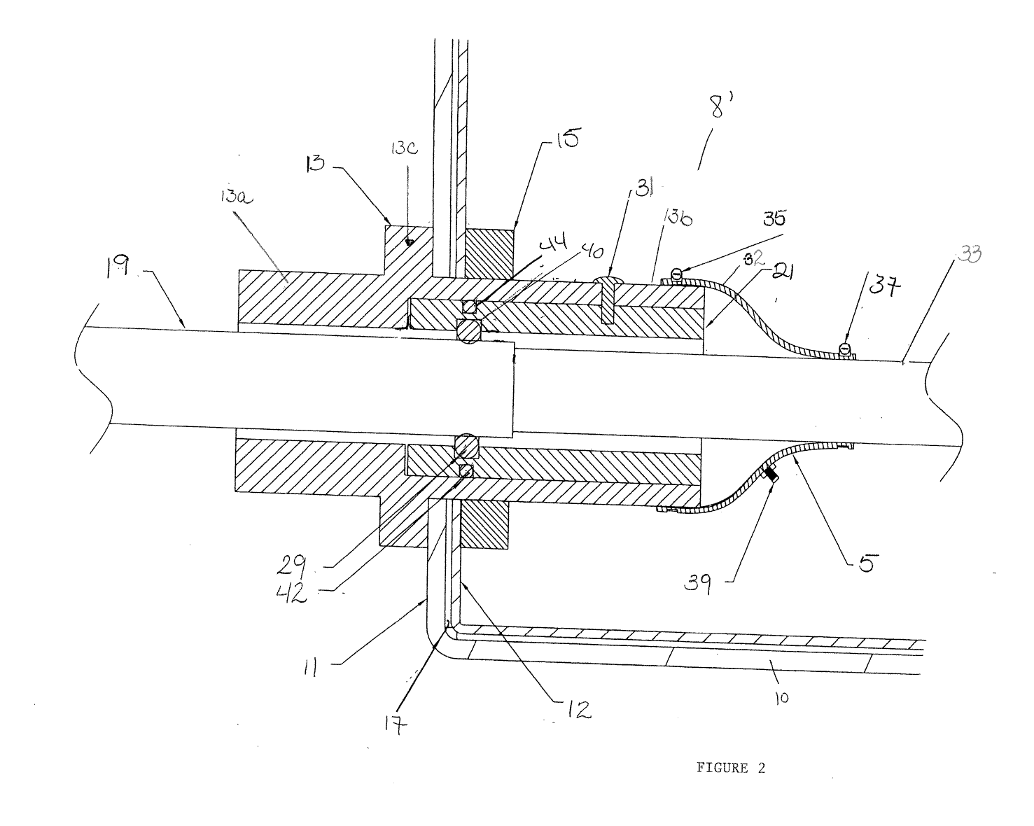

A second embodiment of an entry boot 8′ is illustrated in FIG. 2. Elements common to the first embodiment have the same reference numbers. The entry boot 8′ includes an O-ring seal 29 wedged in a non-mating inner-groove 40 located on an inner surface of the retainer 21. Surfaces that form the non-mating inner-groove 40 are spaced from the main boot 13. The seal 29 may be an O-ring, an annular seal, or the like. In addition, a second seal 42 is wedged in a non-mating outer-groove 44 located on the outer surface of the retainer 21. This outer-groove 44 is adjacent to the inner surface of inner tubular sleeve 13b of main boot 13, but not near first mating inner-groove 23. The second seal 42 is needed in this embodiment as there are no seals located at the first mating inner-groove 23, and liquid may otherwise leak past the inner-groove 40 and into a space between the main boot 13 and the outer surface of the retainer 21. The second seal 42 prevents liquid from leaking any further, thereby sealing the entry boot system. The second seal 42 is typically smaller than the first seal 29, but is also a removable component of the entry boot design.

While the embodiment disclosed in FIG. 2 still includes a first mating inner-groove 23, it does not have either a second mating inner-groove or a mating outer-groove. Instead of inserting the fastener 31 through the surface of inner tubular sleeve 13b that formed the mating outer-groove in FIG. 1, the fastener 31 in FIG. 2 is inserted through the outer surface of inner tubular sleeve 13b (between the ring 4 and clamp 6) and extends inward to attach main boot 13 to retainer 21. The fastener 31 in this embodiment may be a retaining pin. Also, this particular embodiment does not require more than one mating inner-groove because neither seal 29 or 42 is wedged into the first mating inner-groove 23.

While specific embodiments have been illustrated and described, numerous modifications may come to mind without significantly departing from the spirit of the invention, and the scope of protection is only limited by the scope of the accompanying claims.

What is claimed is:

1. For a double-walled chamber having an inner wall, an outer wall, and an opening therethrough, an entry boot for providing a substantially fluid tight seal between the opening and a pipe assembly passing through the opening, the entry boot comprising:
a first tubular fitting comprising a first outer tubular sleeve adapted to be positioned on the outside of the chamber, a first inner tubular sleeve extending through the opening and into the chamber, a radially extending flange located between the first inner and outer sleeves and adapted to engage the outer wall of the chamber, wherein the first tubular fitting has a first mating inner groove;
a second tubular fitting adapted to form a sliding fit with an inner surface of the first inner tubular sleeve and adapted to extend into the first mating inner groove;
sealing means for providing a substantially fluid tight seal between the first tubular fitting and the second tubular fitting and between the second tubular fitting and the pipe assembly;
a retainer ring adapted to engage the first inner tubular sleeve and the inner wall of the chamber; and
a fastener detachably connecting the first inner tubular sleeve to the second tubular fitting.

2. The entry boot of claim 1, wherein the sealing means comprises a seal disposed in the first mating inner groove.

3. The entry boot of claim 2, wherein the seal is an O-ring.

4. The entry boot of claim 1, wherein the sealing means comprises a first seal and a second seal, the first seal being disposed in an inner groove on the inner surface of the second tubular fitting, and the second seal being disposed in an outer groove on the outer surface of the second tubular fitting.

5. The entry boot of claim 4, wherein the first and second seals are O-rings.

6. For a double-walled chamber having an inner wall, an outer wall, and an opening therethrough, an entry boot for providing a substantially fluid tight seal between the opening and a pipe assembly passing through the opening, the entry boot comprising:
a first tubular fitting comprising a first outer tubular sleeve adapted to be positioned on the outside of the chamber, a first inner tubular sleeve extending through the opening and into the chamber, a radially extending flange located between the first inner and outer sleeves and adapted to engage the outer wall of the chamber, wherein the first outer tubular sleeve has a first mating inner groove;
a second tubular fitting having an extension and adapted to form a sliding fit with an inner surface of the first inner tubular sleeve and adapted to extend into the first mating inner groove;
a seal disposed in the first mating inner groove and adapted to engage the extension and the pipe assembly;
a retainer ring adapted to engage the first inner tubular sleeve and the inner wall of the chamber; and
a fastener detachably connecting the first inner tubular sleeve to the second tubular fitting.

7. The entry boot of claim 6, wherein the second tubular fitting further comprises a second mating inner groove, the second mating inner groove is located radially further from the pipe assembly than the first mating inner groove.

8. The entry boot of claim 6, wherein the second tubular fitting further comprises a mating outer groove adapted to mate with a top end of the first inner tubular sleeve, the fastener detachably connects the first inner tubular sleeve and the second tubular fitting at the mating outer groove.

9. The entry boot of claim 6, wherein the flange is adhered to the outer wall of the chamber with a fiberglass joint.

10. The entry boot of claim 6, wherein the retainer ring is adhered to the inner wall of the chamber with a fiberglass joint.

11. The entry boot of claim 6 further comprising a flexible boot that is attached on one end to the first inner tubular sleeve by a first clamp and is attached on the other end to the pipe assembly by a second clamp, wherein the flexible boot has an air valve to adjust and measure pressure fluctuation in a space contained between the flexible boot and the pipe assembly.

12. The entry boot of claim 6, wherein the seal is an O-ring.

13. The entry boot of claim 6, wherein the chamber further comprises an interstitial gap between the inner wall and outer wall of the chamber, the entry boot providing a substantially fluid tight seal between the interstitial gap and the first inner tubular sleeve.

14. The entry boot of claim 6, wherein the pipe assembly comprises a primary wall pipe extending substantially inside the chamber and a secondary wall pipe extending substantially outside the chamber, the primary wall pipe being contained within the secondary wall pipe.

15. The entry boot of claim 14, wherein the first and second tubular fittings both have a substantial fit over the secondary wall pipe.

16. For a double-walled chamber having an inner wall, an outer wall, and an opening therethrough, an entry boot for providing a substantially fluid tight seal between the opening and a pipe assembly passing through the opening, the entry boot comprising:
a first tubular fitting comprising a first outer tubular sleeve adapted to be positioned on the outside of the chamber, a first inner tubular sleeve extending through the opening and into the chamber, a radially extending flange located between the first inner and outer sleeves and adapted to engage the outer wall of the chamber, wherein the first outer tubular sleeve has a first mating inner groove;
a second tubular fitting comprising a non-mating inner groove on an inner surface and a non-mating outer groove on an outer surface, wherein the second tubular fitting is adapted to form a sliding fit with an inner surface of the first inner tubular sleeve and adapted to extend into the first mating inner groove;
a first seal disposed in the non-mating inner groove and adapted to engage the pipe assembly;
a second seal disposed in the non-mating outer groove and adapted to engage the inner surface of the first inner tubular sleeve;
a retainer ring adapted to engage the first inner tubular sleeve and the inner wall of the chamber; and
a fastener detachably connecting the first inner tubular sleeve to the second tubular fitting.

17. The entry boot of claim 16, wherein the first seal is larger than the second seal.

18. The entry boot of claim 17, wherein the first and second seals are both O-rings.

19. The entry boot of claim 16, wherein the fastener extends through an outer surface of the first inner tubular sleeve and into the second tubular fitting.

20. The entry boot of claim 19, wherein the fastener is a retaining pin.

21. The entry boot of claim 16, wherein the flange is adhered to the outer wall of the chamber with a fiberglass joint.

22. The entry boot of claim 16, wherein the retainer ring is adhered to the inner wall of the chamber with a fiberglass joint.

23. The entry boot of claim 16 further comprising a flexible boot that is attached on one end to the first inner tubular sleeve by a first clamp and is attached on the other end to the pipe assembly by a second clamp, wherein the flexible boot has an air valve to adjust and measure pressure fluctuation in a space contained between the flexible boot and the pipe assembly.

24. The entry boot of claim 16, wherein the chamber further comprises an interstitial gap between the inner wall and outer wall of the chamber, the entry boot providing a substantially fluid tight seal between the interstitial gap and the first inner tubular sleeve.

25. The entry boot of claim 16, wherein the pipe assembly comprises a primary wall pipe extending substantially inside the chamber and a secondary wall pipe extending substantially outside the chamber, the primary wall pipe being contained within the secondary wall pipe.

26. The entry boot of claim 25, wherein the first and second tubular fittings both have a substantial fit over the secondary wall pipe.
